(19) United States
(12) Patent Application Publication
(10) Pub. No.: US 2001/0028716 A1
(43) Pub. Date: Oct. 11, 2001

(54) Loudspeaker design method

(76) Inventors: Nicholas P. R. Hill, Cambridge (GB); Vladamir Gontcharov, Cambridgeshire (GB)

Correspondence Address: Alan I Cantor, Foley & Lardner, Washington Harbour, 3000 K Street N W Suite 500, Washington, DC, 20007-5109, US

(21) Appl. No.: 09/784,102

(22) Filed: Feb. 16, 2001

Related U.S. Application Data
(60) Provisional application No. 60/183,326, filed on Feb. 18, 2000.

(30) Foreign Application Priority Data
Feb. 18, 2000 (GB) 0003883.6

(51) Int. Cl. H04R 29/00

(52) U.S. Cl. 381/58; 381/56

(57) ABSTRACT

A method for obtaining a desired level of diffusivity of acoustic output from an acoustic device. The method comprises the steps of measuring at least two responses of the acoustic device, one response being a reference response, and calculating the correlation between each measured response and the reference response; then varying at least one parameter of the acoustic device, remeasuring the at least two responses and calculating the correlation between the remeasured reference response and the other remeasured responses for each variation. The or each parameter of the acoustic device then is selected which gives a correlation closest to a predetermined optimum value so that the desired diffusivity is obtained.

This application claims the benefit of provisional application No. 60/183,326, filed Feb. 18, 2000.

### TECHNICAL FIELD

The invention relates to loudspeakers, more particularly but not exclusively bending wave panel-form loudspeakers, e.g. distributed mode acoustic radiators of the general kind described in International patent application WO97/09842.

### BACKGROUND ART

It is known that the acoustic properties of such distributed mode acoustic radiators differ from those in a conventional pistonic radiator. FIGS. 1a and 1b show, for both a conventional pistonic radiator (dashed line 14) and a distributed mode panel radiator (solid line 16), polar plots of sound pressure level at low frequency (500 Hz) and at high frequency (5 kHz), respectively.

The essential features of the direct sound field of a distributed mode acoustic radiator are an acoustic power that is a smooth function of frequency at low frequency (see FIG. 1a). In contrast, a distributed mode acoustic radiator has a directivity which may display strong small angle fluctuations at higher frequencies (see FIG. 1b) in which there are sound pressure level variations on the scale of 10 dB. The marked difference between the two figures illustrates the strong dependence of the acoustic output on frequency.

An integration of the frequency response of FIG. 1b into octave bands has the effect of averaging the small angle fluctuations, giving rise to the smooth directivity plot shown in FIG. 2. The output of the distributed mode radiator is therefore very similar to a conventional cone loudspeaker when viewed on an octave band scale, while it is the narrow band detail of the distributed mode acoustic radiation that gives rise to its diffuse properties.

When the radiation field is sampled at a single point the small angle fluctuations are manifest as a corresponding fluctuation in the frequency response (18) as shown in FIG. 3a. The upper frequency response (18) is measured in anechoic conditions and the lower frequency response (20) is measured in the presence of a reflecting boundary. The sound pressure level is measured in arbitrary units and the two responses have been separated by 20 dB for clarity. As is clear in FIG. 3a, the presence of a reflecting boundary has relatively little impact on the frequency response from a panel radiator as a result of the diffuse nature of the acoustic output. The diffusivity of a distributed mode acoustic radiator appears to be an inherent property of the direct sound field. The complex structure present in the radiation gives rise to a complex interference pattern when interacting with the boundary which exhibits an average dependence on frequency.

In contrast, a conventional pistonic loudspeaker behaves like a point source and the presence of a boundary has a considerable effect on the frequency response, as shown in FIG. 3b, due to interference between the incident and reflected waves. The upper frequency response (22) is measured in anechoic conditions and the lower frequency response (24) is measured in the presence of a reflecting boundary. The presence of a reflecting boundary significantly reduces the smoothness of the frequency response. The frequency response is determined by the proximity of the loudspeaker to the boundary.

Thus, one principal difference between distributed mode panel radiators and pistonic loudspeakers is the diffuse nature of the radiation field of a distributed mode acoustic radiator, which is responsible for its improved performance in areas such as boundary interaction and room coverage. Diffusivity may arise for a conventional pistonic loudspeaker, but only in terms of the loudspeaker-room interface, where a diffuse field is created after multiple boundary reflections.

FIG. 3c is a schematic illustration of the arrangement for measuring the lower frequency responses shown in FIGS. 3a and 3b, namely the frequency responses in the presence of a reflecting boundary (90) in the form of a hard flat wall. The loudspeaker (92) to be tested is placed close to the reflecting boundary (90) in a free space (94) which has no other reflecting surfaces. A microphone (96) is positioned in front of the loudspeaker (92) to record the acoustic output from the loudspeaker (92). The microphone (96) then sends an input signal to a spectrum analyser (98) which is sent to an amplifier (100). The spectrum analyser (98) comprises an analysis section (97) and a signal generation section (99).

Among the objects of the invention is to provide a method for the characterisation of the direct sound diffusivity for acoustic devices including both conventional pistonic and bending wave panel-form loudspeakers, and to obtain a desired level of diffusivity.

### SUMMARY OF THE INVENTION

According to a first aspect of the invention there is provided a method for obtaining a desired level of diffusivity of acoustic output from an acoustic device, comprising the steps of measuring at least two responses of the acoustic device, one response being a reference response, calculating the correlation between each measured response and the reference response, varying at least one parameter of the acoustic device, remeasuring the at least two responses and calculating the correlation between the remeasured reference response and the other remeasured responses for each variation, and selecting the or each parameter of the acoustic device which gives a correlation closest to a predetermined optimum value so that the desired diffusivity is obtained.

Correlation is a measure of the correspondence between two signals and may be described by mathematical functions. The optimum correlation value may approach zero, representing a decorrelated acoustic device, namely a diffuse source. Generally, diffuse acoustic devices, including panel form bending wave types, exhibit responses where output at any one axis is decorrelated from that at any other axis. Alternatively the optimum correlation value may approach one, representing a non-diffuse source.

Conventional cone type speakers have a correlated sound output since they act as relatively small sources and their energy is largely phase continuous over a quite wide directional angle. When a boundary is presented nearby to the speaker, a clear reflected acoustic image of the source results, which for an observer or listener provides a second signal additional to the first direct sound from the source. The second signal is phase shifted by its longer path relative to the original source signal and thus interferes destructively with the original source signal. This may result in periodic, harmonically related gaps in the spectrum and a consequent loss of information.

Previous attempts to minimise such performance impairment increased the directionality of the speaker so as to increase the ratio of direct path length to reflected path length. Alternatively, complex and costly diffusers were applied to the boundary to provide a diffuse reflection, which is thus decorrelated from the direct signal and results in less harmful effects.

In contrast, the present invention introduces the idea of an acoustic device having decorrelation as an intrinsic property which may be adjusted to achieve a desired diffusion. By controlling levels of diffussivity, it may be possible to improve the acoustic performance in reflective environments. The design of decorrelated acoustic devices, e.g. panel-form loudspeakers may avoid the need for costly, complex sound diffusers.

The responses being correlated may be impulse or frequency responses.

The correlation calculation may use the correlation coefficient (CC) which represents the expectation value of the product of two signals:

CC_{xy}=∫₀^{∞}X(t)·Y(t)dt Equation 1:

x(t), y(t) are the time traces and X(t), Y(t) are the same traces normalised to give an root mean square level of 1. The normalisation ensures that the magnitude of the CC varies between 0 and 1 for perfectly uncorrelated and correlated traces, respectively. A perfectly uncorrelated trace corresponds to a perfectly diffuse source and vice versa.

Preferably, the correlation calculation uses the general cross correlation function (CCF) given below.

CCF_{xy}(τ)=∫_{-∞}^{∞}X(t)·Y(t+τ)dt Equation 2:

This function gives the CC as a function of a time delay T applied to one of the signals. Clearly the CC is equal to CCF at τ=0. The maximum value of the CCF may be the correlation value compared to the predetermined optimum value.

Alternatively, the correlation may be determined from measurements of the frequency response since the time and frequency response are exchangeable via Fourier transform.

The correlation may be calculated for each response in a polar data set and displayed as a correlation polar plot. the correlation polar plot may be obtained by the steps of choosing a single reference angle, for example the on-axis position, calculating the correlation between the response at the reference position and another position of the polar data set, repeating the correlation calculation for every measured response of the polar data set to form a set of correlation responses, and displaying the maximum value of the correlation as a function of angle. Alternatively, the mean value of the correlation may be displayed.

The responses may be filtered to reduce the frequency range of the responses to be correlated. In particular, the responses may be filtered to determine the variation of correlation with frequency. Filtering the original impulse responses allows viewing correlation levels (and diffusivity) as a function of frequency.

The responses may be filtered, e.g. using a bandpass filter. As the filter width is narrowed, the information included in the passband decreases. The filter width may be narrowed to 1-octave or ⅓ octave. A 6^{th} order Butterworth filter may be used. The design of the filter may be determined by the required amplitude response, since the phase response is cancelled by the complex conjugation in the evaluation of the CCF.

As an alternative or in addition to the correlation polar plot, the mean correlation level of each correlation polar plot may be calculated and may further be plotted as a function of frequency. The combination of the plots of average correlation and the individual correlation polar plots is a comprehensive method since it readily yields the dependence of the diffusivity on frequency and its typical distribution with angle.

In one embodiment, the acoustic device may be a conventional pistonic loudspeaker. The optimum correlation value may be one, namely a correlation corresponding to a non-diffuse source.

In another embodiment, the acoustic device may be a bending wave device comprising a panel member for radiating acoustic output and a transducer for exciting bending waves in the panel member. The bending wave device may be a distributed mode acoustic radiator of the general kind described in International patent application WO97/09842 and counterpart U.S. application Ser. No. 08/707,012, filed Sep. 3, 1996 (the latter application being incorporated herein by reference). The optimum correlation value may approach zero, representing a diffuse source.

The parameters being varied are selected from the group comprising the geometry of the panel member including the surface area of the panel member and its aspect ratio, the stiffness of the panel member, the areal mass density of the panel member, damping of the panel member, the location and type of a bending wave transducer on the panel member and the relative phase connections of transducer pairs. An additional parameter which may be altered is the symmetry of the loudspeaker. The symmetry may be broken by varying the exciter position, alternatively placing the panel in a baffle, or changing the geometry of the panel, e.g. aspect ratio.

According to a second aspect of the invention there is provided a method for measuring the spatial diffusivity of acoustic output from an acoustic device, comprising measuring the response of the acoustic device at a reference position and at a comparison position, and calculating the correlation between the response at the reference and the comparison positions to provide a measure of the diffusivity.

Other methods which allow the detailed comparison of angle to angle acoustic output with frequency may give an insight into the randomness of the output of the acoustic device and hence describe diffusivity of radiation.

### BRIEF DESCRIPTION OF THE DRAWING

Examples that embody the best mode for carrying out the invention are diagrammatically illustrated in the accompanying drawing, in which:

FIGS. 1a and 1b are polar plots of the sound pressure level of both a full range pistonic loudspeaker and a distributed mode panel loudspeaker at 500 Hz and at 5 kHz, respectively;

FIG. 2 is a polar plot of the 1-octave smoothed data of FIG. 1b for the distributed mode panel loudspeaker (the smoothing over provides the mean level of the selected band);

FIGS. 3a and 3b are graphs of the frequency response (sound pressure level in arbitrary units against frequency in Hz) of a distributed mode panel loudspeaker and a full range pistonic loudspeaker, respectively;

FIG. 3c is a diagram of the measuring arrangement;

FIGS. 4a and 4b are plots of pressure in arbitrary units against time for two impulse responses;

FIG. 4c is a plot of the CCF (cross-correlation function) versus time for the responses of FIGS. 4a and 4b;

FIG. 5 is a polar plot of the maximum CCF for a distributed mode panel loudspeaker and a cone loudspeaker;

FIG. 6a is a plot of pressure in arbitrary units against time of an unfiltered impulse response;

FIG. 6b is a plot of pressure in arbitrary units against time of the response of FIG. 6a filtered through a 1-octave 1 khz 6^{th} order Butterworth bandpass filter;

FIGS. 7a and 7b are polar plots of the maximum CCF for filtered output of the panel and cone loudspeakers of FIG. 5, respectively;

FIG. 8 is a graph of mean octave band averaged CCF against frequency for both the panel and cone loudspeakers of FIG. 5;

FIG. 9 is a graph of mean CCF against frequency for sets of data at 5° and 20° resolution;

FIG. 10 is a graph of mean CCF against frequency for reference positions on axis and 30° off-axis;

FIG. 11 is a graph of the mean CCF versus frequency for two panels of differing rigidity;

FIG. 12a is a graph of the mean CCF versus frequency for three panels of differing area;

FIG. 12b is a graph of the mean CCF versus frequency for two panels of greatly differing area;

FIG. 13 is a graph of the mean CCF versus frequency for a rectangular panel loudspeaker calculated from data measured in the portrait and landscape plane;

FIG. 14 shows graphs of the mean CCF versus frequency for a panel loudspeaker excited by either a single exciter or two exciters;

FIG. 15 is a side view of a panel loudspeaker;

FIG. 16a shows polar plots at 1 kHz of the CCF for a panel loudspeaker driven at the centre and at the edge;

FIG. 16b is a graph of the mean CCF versus frequency for a panel loudspeaker either with a centrally placed or an edge placed exciter;

FIG. 17 is a flow chart showing the steps of a method of measuring diffusivity of an acoustic object, and

FIG. 18 is a flow chart showing the steps of a method for designing an acoustic object according to the invention.

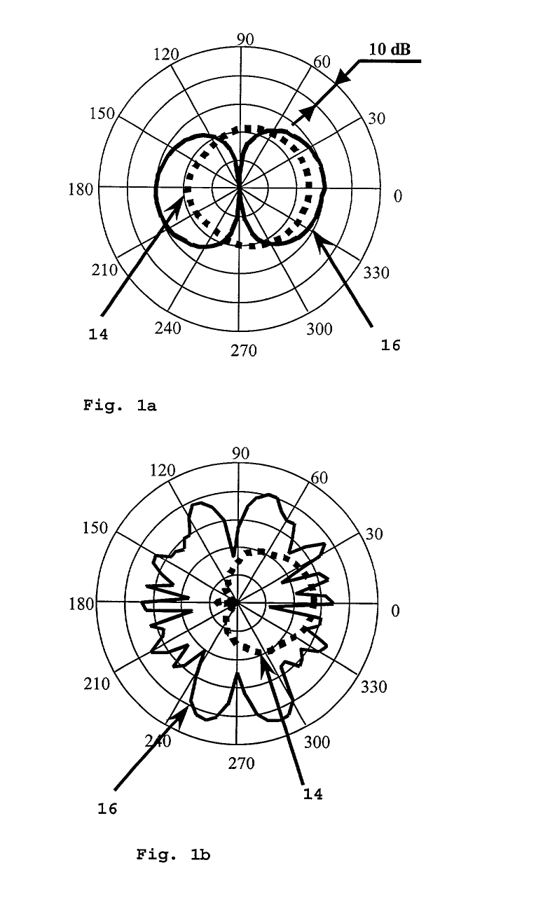

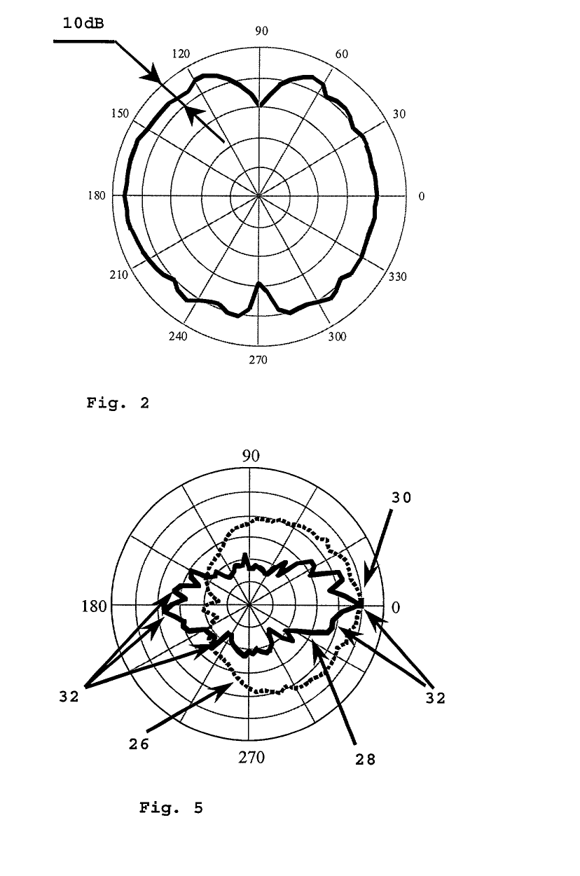

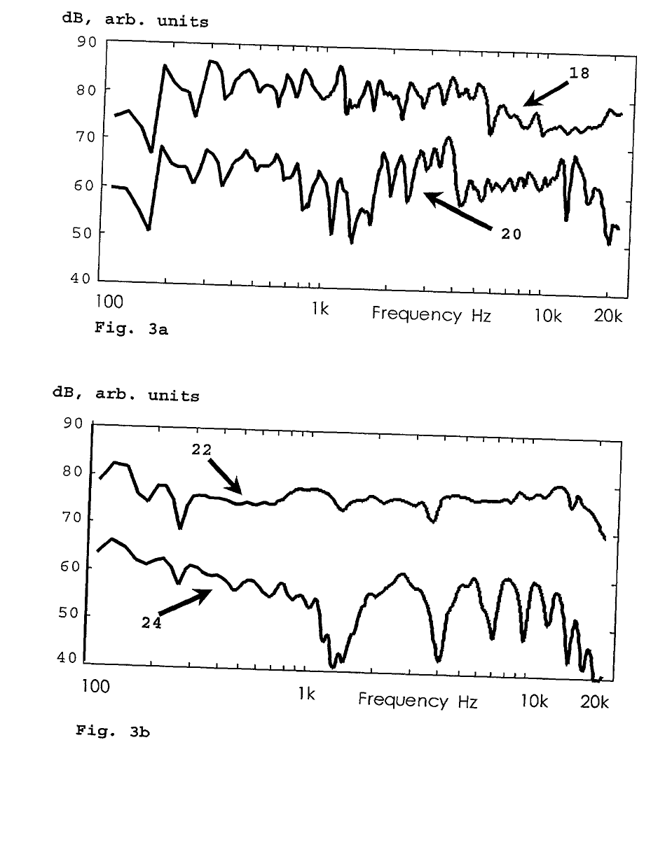

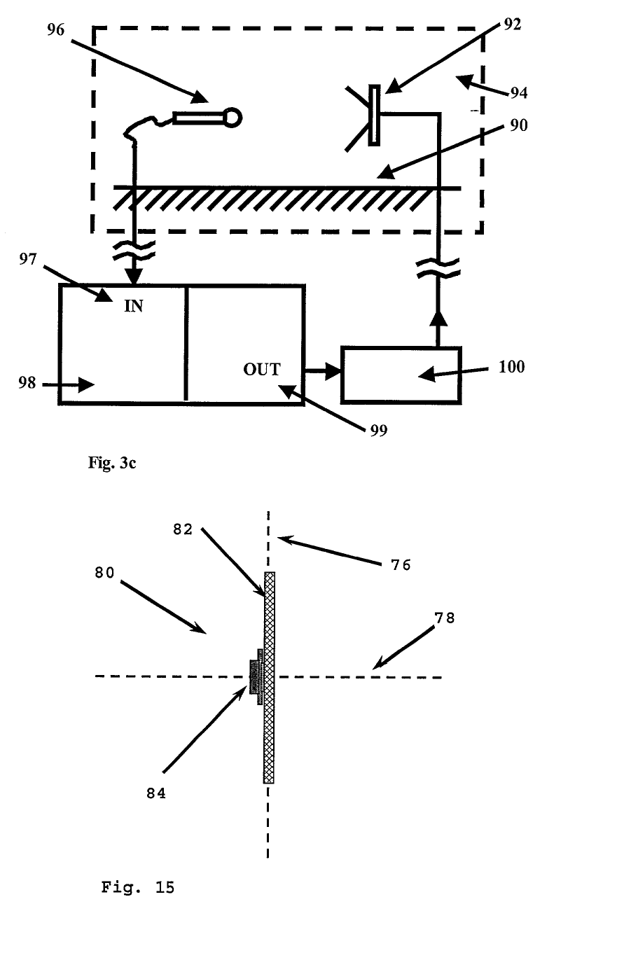

### DETAILED DESCRIPTION

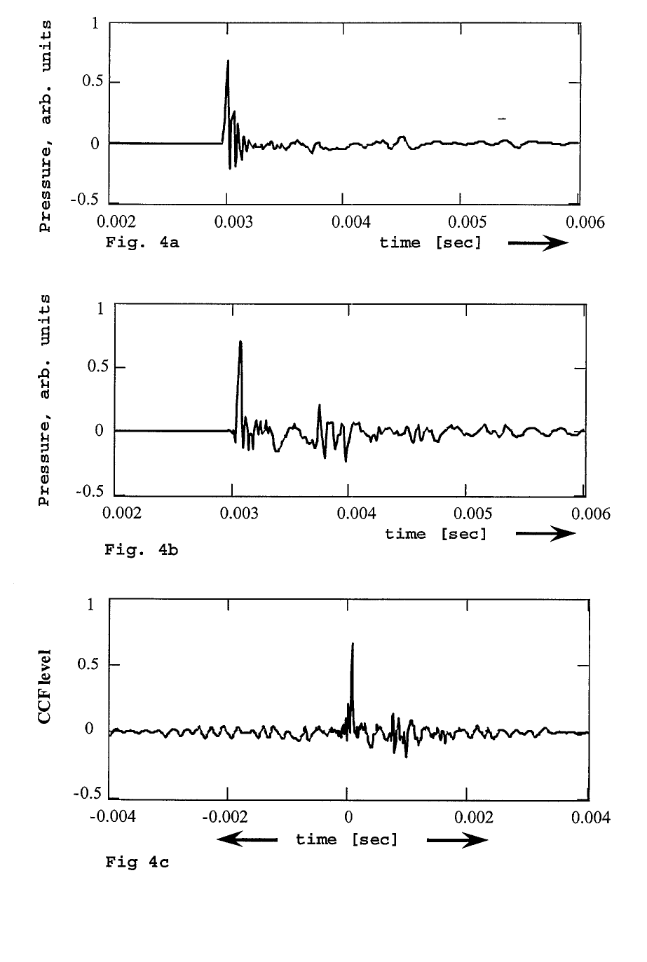

FIGS. 4a, 4b, 4c and 5 illustrate the first steps of the method to achieve the desired diffusivity of a source. FIGS. 4a and 4b show two impulse responses measured at the on-axis position and 35 degrees off axis respectively. The responses are taken from a polar set of responses for a bending wave action loudspeaker. The CC (correlation coefficient) is calculated using equation 1 to be 0.09 indicating that the correlation between the two responses is small.

FIG. 4c shows the CCF (cross correlation function) calculated using equation 2. It is clear that the maximum CCF value is shifted from the τ=0 position. This is due to the slight difference in the initial time delay of the two measured impulses. As a result, the CC (which is equal to CCF at τ=0) does not represent the true correlation of the two signals. Thus, the correlation between two measured responses may be found by determining the maximum value of the CCF. The maximum value of the CCF may be calculated for each response in the polar set and plotted as a correlation polar plot.

FIG. 5 shows correlation polar plots (28,26) for both a bending wave panel loudspeaker (panel 1) of the general kind described in International patent application WO97/09842 and counterpart U.S. application Ser. No. 08/707,012, and a conventional full range cone loudspeaker (cone), each with the following details. Panel 1 and the cone were used in all examples, unless otherwise indicated. The loudspeakers were positioned on a rotating table and the impulse response measured at lm distance with 5° angular resolution.

| Panel 1 | Cone |
|---|---|
| Area = 0.261 m², (48.0 × 54.4 cm) | Model: Mission 750, full |
| Thickness = 4 mm | range 2-way loudspeaker |
| Bending Stiffness: 13.6 Nm; | |
| Surface density: 0.76 kg/m²; | |

The two correlation polar plots exhibit strikingly different behaviour. Both traces have a value of 1 on-axis, corresponding to the correlation of the reference position (30) with itself (known as auto-correlation). As the angle from the on-axis increases, the correlation of the cone loudspeaker remains high and only decreases significantly for positions behind the front face of the loudspeaker. The panel speaker on the other hand is characterised by a narrow set of angles (32) where the output remains well correlated to the reference position, and outside of which the correlation falls off rapidly.

The cone loudspeaker represents a source with a broad angle directivity and high correlation, whereas the panel loudspeaker exhibits a broad angle directivity but a correlation that falls off rapidly with angle.

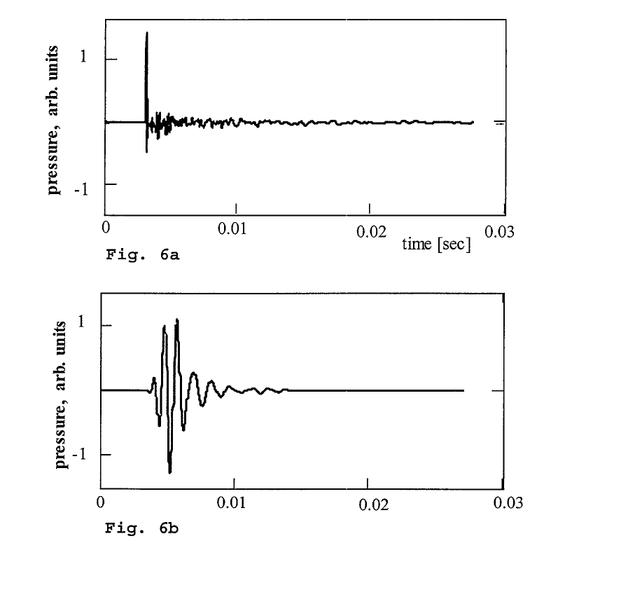

Before calculating the correlation, the response data may be filtered to see the dependence of correlation on frequency. FIGS. 6a and 6b show the effect of filtering a response using a 1 octave 6^{th} order Butterworth filter. In FIG. 6a there is shown an unfiltered impulse response and in FIG. 6b, the impulse of FIG. 6a has been filtered into a 1 octave band around 1 kHz.

In general, the decorrelation of the radiation field is a wide band property, increasing with the more information included in the individual responses. The choice of filter to calculate its frequency dependence is therefore quite arbitrary, and the correlation level should be quoted as a level for a given frequency and filter characteristic. The order of filter used does not strongly affect the result, provided it is high enough that the effective width of the filter is not increased. In the following examples, a 1 octave 6^{th} order Butterworth bandpass filter has been employed.

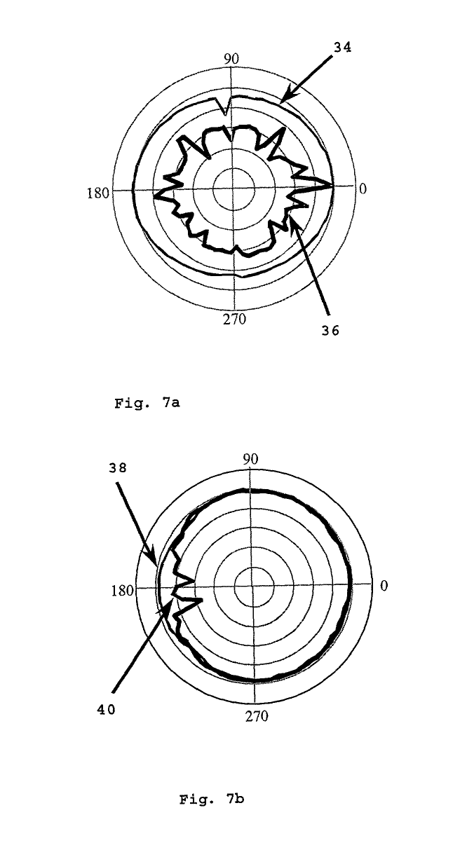

FIG. 7a shows maximum CCF polar responses (34,36) for the panel loudspeaker (panel 1) for filter centres of 500 Hz and 5 kHz, respectively. Similarly, FIG. 7b shows maximum CCF polar responses (38,40) for the cone loudspeaker (cone) for filter centres of 500 Hz and 5 kHz, respectively.

In FIG. 7a, the CCF polar plot is approximately circular for the panel at the low frequency (500 Hz), except directly off axis. The general trend of the plot at high frequency (5 kHz) is to narrow from the off axis positions. The correlation level falls off rapidly with increasing angle from the on-axis reference position reaching its minimum approximately 90 degrees off axis but rises again behind the panel.

In FIG. 7b, the CCF polar plots relating to the cone loudspeaker in the figure exhibit very different behaviour. The correlation level over the front hemisphere remains close to unity.

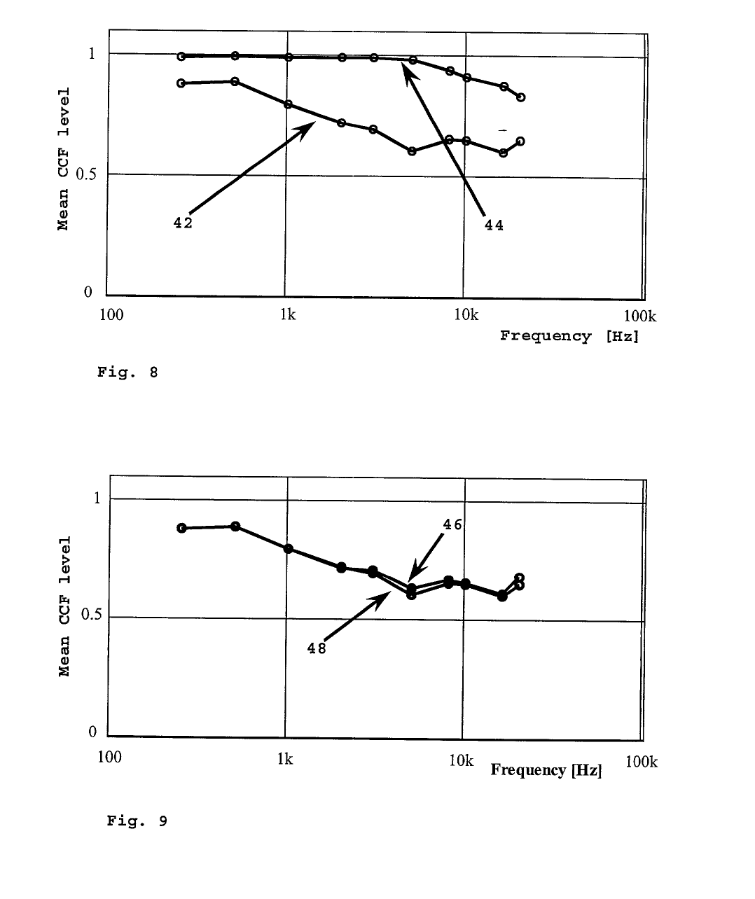

As an alternative to the maximum CCF used previously, a mean, or average, level of CCF polar response may be used. Such a mean level may be the average of all maximum CCF values of the CCF polar response and may be plotted against frequency to give a mean CCF frequency response for a loudspeaker. FIG. 8 shows the mean CCF frequency response (42,44) for the panel and cone loudspeakers described above. The mean CCF frequency response (42) for a panel loudspeaker falls off with frequency. In contrast, the mean CCF frequency response (44) is generally flat and remains close to unity confirming that the cone loudspeaker is essentially a non- diffuse source. This is a very illustrative graph which may be used to identify a diffuse sound source and provide a numerical description of the level of diffusivity.

FIG. 9 shows two mean CCF frequency responses (46,48) where the polar data was measured with 5° resolution and 20° resolution respectively. The two responses (46,48) are virtually identical and thus it appears that the correlation method of describing diffusivity does not strongly depend on the amount of data in the set of impulse/frequency responses provided the measurement space around a loudspeaker is sufficiently covered.

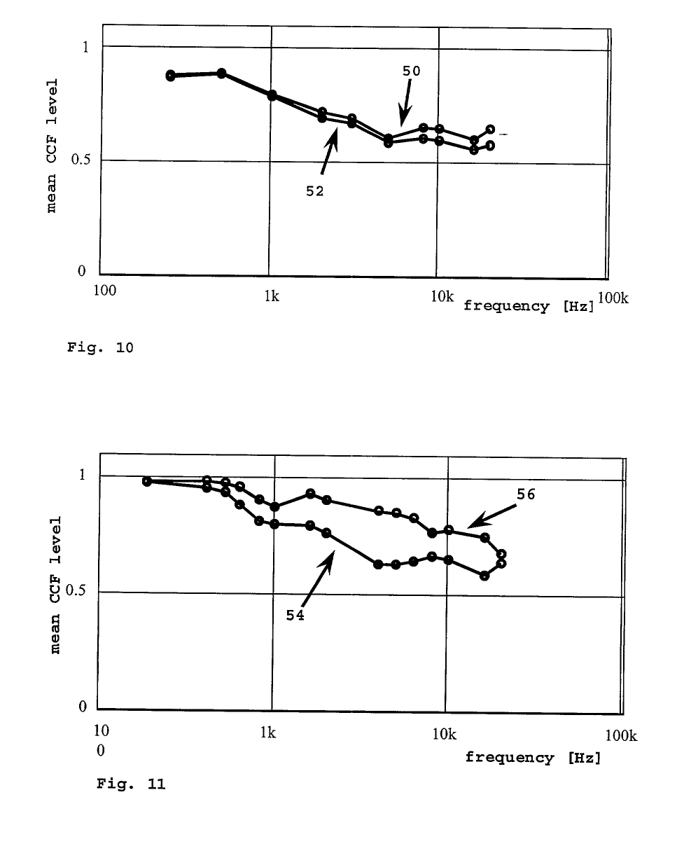

FIG. 10 illustrates two mean CCF frequency responses (50,52) calculated with on axis and 30° off axis reference positions, respectively. Since the responses (50,52) are similar, the evaluation of diffusivity does not appear to be strongly affected by choice of the off-axis reference position.

Since the average correlation level is neither strongly sensitive to the resolution of the measured data nor the reference position, it is a robust measure of the diffusivity.

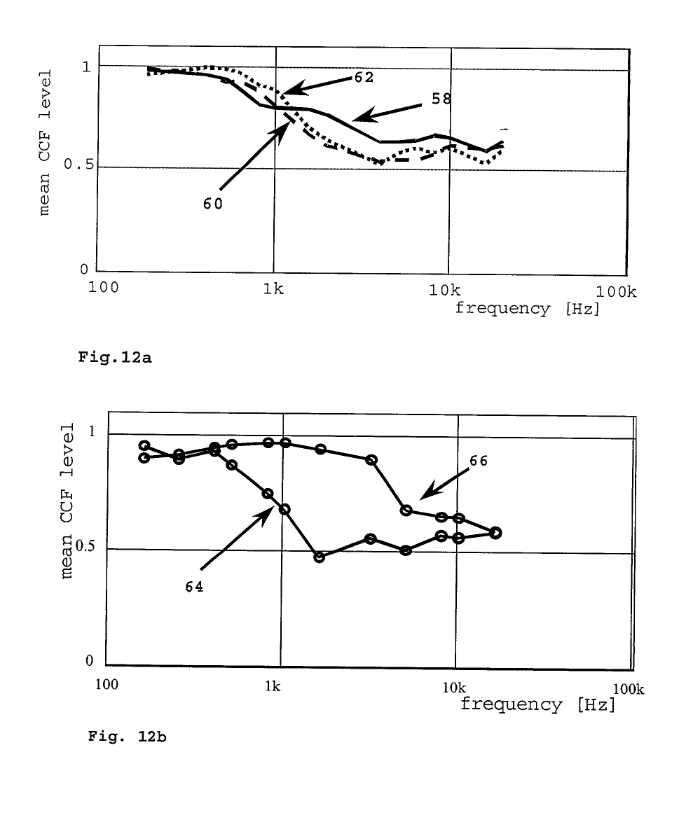

The effects of varying panel parameters to achieve a desired level of diffusivity are shown in FIGS. 11, 12a and 12b. Each panel differs from panel 1 by at least one parameter e.g. area or bending stiffness. Each panel is measured in the same conditions and the mean CCF frequency responses were calculated for each. The results of the correlation analysis for each panel may then be compared to determine which of the panels has a correlation closest to the predetermined optimum value. For example, to achieve a diffuse source, a correlation approaching 0 may be optimum.

FIG. 11 shows two mean CCF frequency responses (54, 56) for panel 1 and a second panel (panel 2). Panel 2 is the same size as panel 1 but has a bending rigidity of 0.68 Nm which is approximately a factor of 20 less than the rigidity of panel 1. Panel 2 is also thinner than panel 1 having a thickness of 2 mm and is less dense than panel 1 having a density of 0.406 kg/m².

The mean CCF levels are lower for panel 1, across the whole frequency spectrum. For Panel 2, the mean CCF levels stay closer to unity than for Panel 1 over the whole frequency band, with only a slow fall-off at higher frequencies. These high CCF levels result from the correlated sound field. Thus, for greater diffusing panel 1 is preferable to panel 2 since panel 2 has a more correlated sound field.

FIG. 12a shows mean CCF frequency responses (58, 60, 62) for the following panels, over a range of axes.

| | Panel 1 | Panel 3 | Panel 4 |
|---|---|---|---|
| Area (m²) | 0.261 | 0.059 | 0.035 |
| Thickness (mm) | 4 | 4 | 4 |
| Bending Stiffness (Nm) | 13.6 | 13.6 | 13.6 |
| Surface density (kg/m²) | 0.76 | 0.76 | 0.76 |

The traces show some minor differences, however it is clear that the overall behaviour of the mean CCF levels is very similar. Accordingly, panels 1, 3 and 4 are all equally diffuse. Thus, this variation in the size of the panel does not strongly influence the CCF levels. However, FIG. 12b compares the following two panels which differ greatly in size by a factor of 20. Both panels are made of the same material and have same aspect ratio:

| | Panel 5 | Panel 6 |
|---|---|---|
| Size (mm × mm) | 338 × 398 | 76 × 89 |
| Thickness (mm) | 5 | 5 |
| Bending Stiffness (Nm) | 21.3 | 21.3 |
| Surface density (kg/m²) | 0.94 | 0.94 |

FIG. 12b shows mean CCF frequency responses (64, 66) for panels 5 and 6 having areas of 0.135 m² and 0.007 m². Clearly, diffusivity is dependent on size with the smaller panel being much more correlated and hence less diffuse.

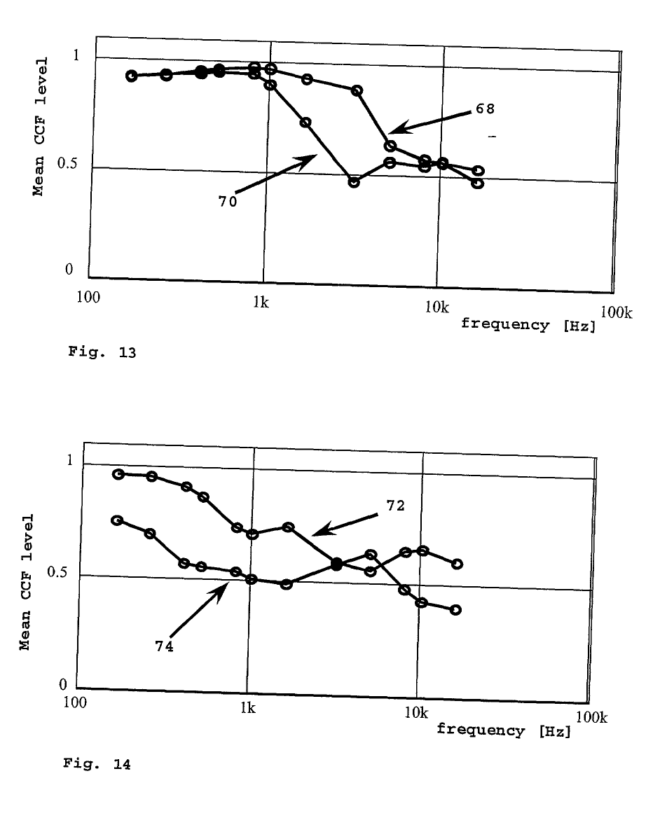

The panels 5 and 6 are of moderate damping whereas the panels 1, 3 and 4 possess low damping. FIG. 13 shows mean CCF frequency responses (68, 70) for panel 7 calculated using data measured in two different planes, namely portrait and landscape, respectively. Panel 7 has the same properties as panel 6 except that panel 7 has a high aspect ratio (7.6 cm by 39.8 cm). FIG. 13 shows that the correlation and hence diffusivity is different for each plane.

FIG. 14 shows how the type of excitation affects diffusivity of a panel. Panel 1 was measured when driven with a single exciter (direct excitation) and alternatively by two exciters connected electrically out of phase in a bender arrangement. The second type of excitation produces predominately bending motion in the panel. The mean CCF frequency responses (72, 74) for such single and double exciter excitation are shown in FIG. 14. Generally, the correlation of the bending exciter case is significantly less than that of the single exciter excitation.

As shown in FIG. 15 a panel loudspeaker (80) has two lines of symmetry, namely a plane of symmetry (76) parallel to the panel surface and a plane perpendicular (78) to the panel. The physical symmetry of the panel loudspeaker (80) is reflected in the CCF polar plot for example, in FIG. 5. The forward radiation at a particular angle is approximately equivalent to the rear radiation at the symmetric position which reflects the parallel plane of symmetry.

The symmetry about the plane perpendicular to the panel (82) surface is dependent on the location of exciter (84) on the panel. When the exciter (84) is attached to the panel (82) relatively near to its centre, the natural symmetry of the panel (82) is preserved.

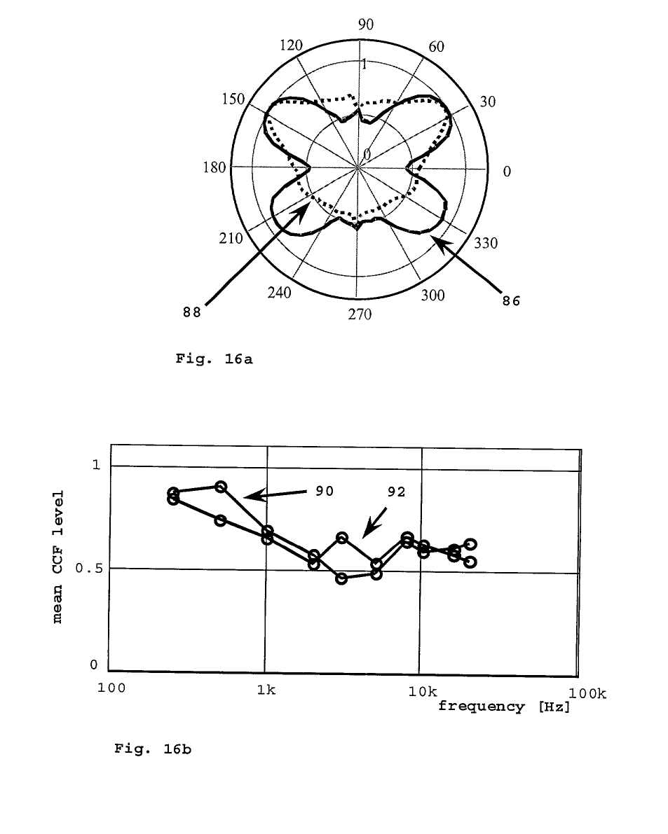

FIGS. 16a and 16b show the dependence of diffusivity on symmetry of driving unit location. If the driver is placed in the centre of the panel it will produce so called ‘symmetry maximums’ of correlation. If the panel is driven from the edge, it will reduce the symmetry reducing the maximums of correlation. In FIG. 16a, the polar plots (86, 88) are respectively for a centrally driven and an edge driven panel loudspeaker at 1 kHz. The correlation for the edge driven panel loudspeaker is less than that for the centrally driven loudspeaker. However, in FIG. 16b, the mean CCF frequency responses (90,92) for the centrally driven and edge driven case, respectively, show similar levels of diffusivity.

It will be appreciated that the front to rear symmetry of the system may be broken in other ways, e.g. by use of a baffle or even a rear enclosure in a closed-back panel loudspeaker.

FIG. 17 is a flow chart showing steps in a method of measuring diffusivity, namely:

a) Choose reference position and measure response.

b) Choose one or more other positions and measure the response.

c) OPTIONAL. If frequency resolution is required, filter the response into one or more bands, e.g. using a bandpass filter.

d) Calculate the correlation level of the reference position to other positions. This may be done using equations 1 or 2 or, alternatively, using another method of correlating, i.e. comparing, the two signals. The correlation may be, for example, a maximum or a mean value.

e) Plot the correlation levels as a function of angle from reference position and/or the frequency range of the filter.

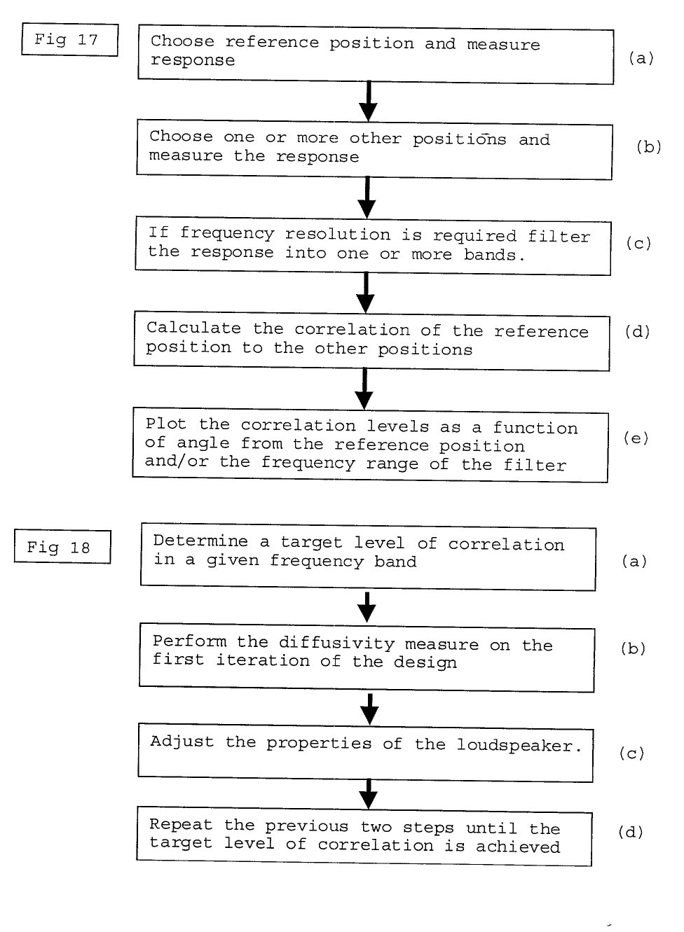

FIG. 18 shows how the method of FIG. 17, or a similar method, may be used to improve the performance of a loudspeaker. The steps of the method shown in FIG. 18 are:

a) Determine a target level of correlation in a given frequency band, for example, for a diffuse source, a target level approaching zero may be suitable.

b) Perform a method of measuring diffusivity, e.g. as set out in FIG. 17.

c) Adjust the properties of the loudspeaker, for example rigidity or size of the panel and/or type or placement of the exciter.

d) Repeat steps (b) and (c) until the target level of correlation is achieved.

The invention thus provides a way of improving the performance of an acoustic object using a measure of its diffusivity, e.g. correlation.

The entire disclosure of provisional application No. 60/183,326 is incorporated herein by reference.

1. A method for obtaining a desired level of diffusivity of acoustic output from an acoustic device, comprising the steps of measuring at least two responses of the acoustic device, one response being a reference response, calculating the correlation between each measured response and the reference response, varying at least one parameter of the acoustic device, remeasuring said at least two responses and calculating the correlation between the remeasured reference response and the other remeasured responses for each variation, and selecting the or each parameter of the acoustic device which gives a correlation closest to a predetermined optimum value so that the desired diffusivity is obtained.

2. A method according to claim 1, wherein the responses being correlated are impulse or frequency responses.

3. A method according to claim 2, wherein the responses are filtered to reduce the frequency range of the responses to be correlated.

4. A method according to claim 1 or claim 2, wherein the correlation calculation uses a correlation coefficient (CC) which represents the expectation value of the product of two signals, and given by the equation:
CC_{xy}=∫₀^{∞}X(t)·Y(t)dt
where x(t), y(t) are the time traces and x(t), y(t) are the same traces normalised to give an root mean square level of 1.

5. A method according to claim 4, wherein the correlation calculation uses a general cross correlation function (CCF) given by the equation:
CCF_{xy}(τ)=∫_{-∞}^{∞}X(t)·Y(t+τ)dt
where the CC is given as a function of a time delay τ applied to one of the signals.

6. A method according to claim 5, wherein the correlation is calculated for each response in a polar data set and displayed as a correlation polar plot.

7. A method according to claim 6, wherein the mean correlation level of each correlation polar plot is calculated and is further plotted as a function of frequency.

8. A method according to claim 6, where the correlation polar plot is obtained by the steps of choosing a single reference angle, calculating the correlation between the response at the reference position and another position of the polar data set, repeating the correlation calculation for every measured response of the polar data set to form a set of correlation responses, and displaying the maximum value of the correlation as a function of angle.

9. A method according to claim 4, wherein the correlation is calculated for each response in a polar data set and displayed as a correlation polar plot.

10. A method according to claim 9, wherein the mean correlation level of each correlation polar plot is calculated and is further plotted as a function of frequency.

11. A method according to claim 9, where the correlation polar plot is obtained by the steps of choosing a single reference angle, calculating the correlation between the response at the reference position and another position of the polar data set, repeating the correlation calculation for every measured response of the polar data set to form a set of correlation responses, and displaying the maximum value of the correlation as a function of angle.

12. A method according to claim 2, wherein the correlation is calculated for each response in a polar data set and displayed as a correlation polar plot.

13. A method according to claim 12, wherein the mean correlation level of each correlation polar plot is calculated and is further plotted as a function of frequency.

14. A method according to claim 12, where the correlation polar plot is obtained by the steps of choosing a single reference angle, calculating the correlation between the response at the reference position and another position of the polar data set, repeating the correlation calculation for every measured response of the polar data set to form a set of correlation responses, and displaying the maximum value of the correlation as a function of angle.

15. A method according to claim 1, wherein the correlation is calculated for each response in a polar data set and displayed as a correlation polar plot.

16. A method according to claim 15, wherein the mean correlation level of each correlation polar plot is calculated and is further plotted as a function of frequency.

17. A method according to claim 15, where the correlation polar plot is obtained by the steps of choosing a single reference angle, calculating the correlation between the response at the reference position and another position of the polar data set, repeating the correlation calculation for every measured response of the polar data set to form a set of correlation responses, and displaying the maximum value of the correlation as a function of angle.

18. A method for obtaining a desired level of diffusivity of acoustic output from a bending wave acoustic device comprising a panel member for radiating acoustic output and a transducer for exciting bending waves in the panel member, the method comprising the steps of measuring at least two responses of the acoustic device, one response being a reference response, calculating the correlation between each measured response and the reference response, varying at least one parameter of the acoustic device, remeasuring said at least two responses and calculating the correlation between the remeasured reference response and the other remeasured responses for each variation, and selecting the or each parameter of the acoustic device which gives a correlation closest to a predetermined optimum value so that the desired diffusivity is obtained.

19. A method according to claim 18, wherein the parameters that can be varied are selected from the group consisting essentially of the geometry of the panel member, the stiffness of the panel member, the areal mass density of the panel member, damping of the panel member, the location and type of a bending wave transducer on the panel member and the relative phase connections of transducer pairs.

20. A method according to claim 19, wherein the geometric parameters are selected from the group consisting essentially of the surface area of the panel member and the aspect ratio of the panel member.

21. A method according to claim 18, wherein the responses being correlated are impulse or frequency responses.

22. A method according to claim 21, wherein the responses are filtered to reduce the frequency range of the responses to be correlated.

23. A method according to claim 18 or claim 21, wherein the correlation calculation uses a correlation coefficient (CC) which represents the expectation value of the product of two signals, and given by the equation:
CC_{xy}=∫₀^{∞}X(t)·Y(t)dt
where x(t), y(t) are the time traces and X(t), Y(t) are the same traces normalised to give an root mean square level of 1.

24. A method according to claim 23, wherein the correlation calculation uses a general cross correlation function (CCF) given by the equation:
CCF_{xy}(τ)=∫_{-∞}^{∞}X(t)·Y(t+τ)dt
where the CC is given as a function of a time delay τ applied to one of the signals.

25. A method according to claim 24, wherein the correlation is calculated for each response in a polar data set and displayed as a correlation polar plot.

26. A method according to claim 25, wherein the mean correlation level of each correlation polar plot is calculated and is further plotted as a function of frequency.

27. A method according to claim 25, where the correlation polar plot is obtained by the steps of choosing a single reference angle, calculating the correlation between the response at the reference position and another position of the polar data set, repeating the correlation calculation for every measured response of the polar data set to form a set of correlation responses, and displaying the maximum value of the correlation as a function of angle.

28. A method according to claim 23, wherein the correlation is calculated for each response in a polar data set and displayed as a correlation polar plot.

29. A method according to claim 28, wherein the mean correlation level of each correlation polar plot is calculated and is further plotted as a function of frequency.

30. A method according to claim 28, where the correlation polar plot is obtained by the steps of choosing a single reference angle, calculating the correlation between the response at the reference position and another position of the polar data set, repeating the correlation calculation for every measured response of the polar data set to form a set of correlation responses, and displaying the maximum value of the correlation as a function of angle.

31. A method according to claim 21, wherein the correlation is calculated for each response in a polar data set and displayed as a correlation polar plot.

32. A method according to claim 31, wherein the mean correlation level of each correlation polar plot is calculated and is further plotted as a function of frequency.

33. A method according to claim 31, where the correlation polar plot is obtained by the steps of choosing a single reference angle, calculating the correlation between the response at the reference position and another position of the polar data set, repeating the correlation calculation for every measured response of the polar data set to form a set of correlation responses, and displaying the maximum value of the correlation as a function of angle.

34. A method according to claim 18, wherein the correlation is calculated for each response in a polar data set and displayed as a correlation polar plot.

35. A method according to claim 34, wherein the mean correlation level of each correlation polar plot is calculated and is further plotted as a function of frequency.

36. A method according to claim 34, where the correlation polar plot is obtained by the steps of choosing a single reference angle, calculating the correlation between the response at the reference position and another position of the polar data set, repeating the correlation calculation for every measured response of the polar data set to form a set of correlation responses, and displaying the maximum value of the correlation as a function of angle.

37. A method for measuring the spatial diffusivity of acoustic output from an acoustic device, comprising measuring the response of the acoustic device at a reference position and at a comparison position, and calculating the correlation between the response at the reference and the comparison positions to provide a measure of the diffusivity.
